(19) United States
(12) Patent Application Publication
(10) Pub. No.: US 2009/0052804 A1
(43) Pub. Date: Feb. 26, 2009

(54) METHOD PROCESS AND APPARATUS FOR AUTOMATED DOCUMENT SCANNING AND MANAGEMENT SYSTEM

(75) Inventor: William Frederick Lewis, Washington, DC (US)

Correspondence Address: BELL, BOYD, & LLOYD LLP, P.O. BOX 1135, CHICAGO, IL, 60690, US

(73) Assignee: Prospect Technologies, Inc., Washington, DC (US)

(21) Appl. No.: 12/195,973

(22) Filed: Aug. 21, 2008

Related U.S. Application Data
(60) Provisional application No. 60/957,333, filed on Aug. 22, 2007.

(51) Int. Cl. G06K 9/32

(52) U.S. Cl. 382/298

(57) ABSTRACT

An automated system and method for storing document data in a Web based document management system is provided. The method includes specifying a first identifier, scanning a document to produce an image file and resizing the image file to produce a resized image. The resized image has a width that is less than or equal to a maximum width at which a display unit can display the resized image entirely without resizing the resized image further or at which a printer can print the resized image entirely without further resizing the resized image. The method also includes extracting text data from the image file or the resized image file to produce a text file, uploading the text file and image file to a server, indexing the text file and image file in the server, and making the text file and image file accessible via the Internet by a web browser. Scanning, resizing, extracting, uploading, indexing and making are performed automatically substantially without manual interference between scanning, resizing, extracting, uploading, indexing and making.

### PRIORITY CLAIM

This application claims priority to U.S. Provisional Application Ser. No. 60/957,333, filed Aug. 22, 2007 and entitled “METHOD, PROCESS, AND APPARATUS FOR AUTOMATED DOCUMENT SCANNING AND MANAGEMENT SYSTEM,” the entire contents of which are hereby incorporated by reference.

### BACKGROUND

Scanners exist as stand-alone units or part of multi-functional devices, such as multi-function printers (“MFP”). After a document that includes text is scanned into a system using a scanner, optical character recognition (“OCR”) can be performed at the request of a user to extract letters, words and other symbols from the image file. After extraction, typically the accuracy of the extraction is manually checked before the textual data extracted from the image file is stored as a text-based file. However, such a manual process is inefficient, time-consuming, and not very user-friendly.

### SUMMARY

A system and method for storing document data is provided. The method includes specifying a first identifier, scanning a document to produce an image file and resizing the image file to produce an optimized image. The resized image has a width that is less than or equal to a maximum width at which a display unit can display the resized image entirely without resizing the resized image further or at which a printer can print the resized image entirely without further resizing the resized image. In one embodiment, the method includes extracting text data from the image file to produce a text file and (e.g., before or after the image file is optimized); however, it should be appreciated that the text data can be extracted from the optimized image file. The method also includes generating metadata associated with the text and image files; uploading the text file, metadata, and image file to a server; indexing the text file, meta data, and image file in the server; and making the text file, meta data, and image file accessible via a network (e.g., the Internet) through a web browser. In one embodiment, the scanning, resizing, extracting, uploading, indexing and making are performed automatically substantially without manual interference between scanning, resizing, extracting, uploading, indexing and making. It should also be appreciated that the resizing, extracting, uploading, indexing, and making can be performed in any suitable order.

In one embodiment, the method includes generating thumbnail image files of at least one scanned image file. In one alternative embodiment, the method includes generating a Portable Document Format (PDF) file of at least one scanned image.

In one embodiment, a network available or Web based system and automated process for inputting and storing documents data is described. The process of this embodiment:
Enables a user to scan one or more documents (e.g., capturing an image) with at least one MFP (an MFP hereinafter can include a multi-function printer or any other suitable electronic device like a device dedicated to scanning documents, images, or any other suitable item),
Identifies the documents via at least one identifier (e.g., text or other suitable metadata identifier) at the MFP or other suitable electronic device,
Saves the scanned image in at least one image format (e.g., TIFF, JPEG, or any other suitable file type like PDF),
Processes the scanned image using OCR to produce at least one file including text which is associated or ‘bundled’ along with the image file,
Resizes and saves the at least one image file to an optimized size in any suitable format (if necessary) to a) improve image quality; as well as b) allow satisfactory printing of the document image/photo,
Generates at least one thumbnail image and at least one PDF of the at least one optimized image file,
Enables metadata to be created for any file stored in the system (including the at least one text file and the at least one optimized image file), wherein the metadata is automatically generated or user generated,
Transmits the at least one optimized image file, at least one associated text file, and any associated metadata to a predetermined computer/server (e.g., using FTP or any other suitable transmission protocol),
Indexes the text file and any metadata associated any other transmitted files (e.g., the optimized image file) to allow immediate access to both the optimized image file and text file, thereby allowing the scanned document to be instantly searched and retrieved. This search can be performed as a simple Web or ‘Google-like’ search (e.g. Boolean operator based search, or using any other suitable search system interface), and
Enables the optimized image and associated text file to be accessible via an electronic network to be shared, stored, manipulated, etc. by a user (e.g., such as accessible through the Internet via an online unsecured or secure document management software).

Please note that in one embodiment, the steps enumerated above (e.g., scanning, resizing, extracting, uploading, indexing and making) are performed substantially automatically without any manual interference between scanning, resizing, extracting, uploading, indexing and making.

Additional features and advantages are described herein, and will be apparent from, the following Detailed Description and the figures.

### BRIEF DESCRIPTION OF THE FIGURES

FIGS. 1A and 1B are block diagrams of systems in accordance with various embodiments.

FIG. 2 is a block diagram of objects and actions associated with an MFP computer in accordance with one embodiment.

FIG. 3 is a block diagram of a section of a display screen of an uploaded file in both an image and text form in accordance with one embodiment.

FIG. 4 is a block diagram of objects and actions associated with a secure server farm in accordance with one embodiment.

FIGS. 5A and 5B are flow diagrams of the processes of automatically uploading documents in accordance with various embodiments.

FIG. 6 is a block diagram of a section of a display screen in which a Uniform Resource Locator (URL) address is displayed in accordance with one embodiment.

FIG. 7 is a block diagram of a section of a display screen when a mouse is passed over an active URL, wherein for security reasons the URL location is not allowed to be displayed in accordance with one embodiment.

FIG. 8 is a block diagram of a section of a display screen in which text can be edited to correct OCR errors or for any other suitable reason in accordance with one embodiment.

FIG. 9 is a block diagram of a section of a display screen in which verification that text was edited is displayed in accordance with one embodiment.

FIG. 10 is a block diagram of a tree-structure of files/folders in a document management system's public area in accordance with one embodiment.

FIG. 11 is a block diagram of a tree-structure of files/folders in a document management system's private area in accordance with one embodiment.

FIG. 12 is a block diagram of a section of a display screen in which different search options are displayed in accordance with one embodiment.

FIG. 13 is a block diagram of how a document management system searches the public folders and files in accordance with one embodiment.

FIG. 14 is a block diagram of how a document management system searches the private folders and files in accordance with one embodiment.

FIG. 15 is a block diagram showing that once indexed, a document management system can find files in public folders in accordance with one embodiment.

FIG. 16 is a block diagram showing that once indexed, a document management system can find files in private folders in accordance with one embodiment.

FIG. 17 is a block diagram of how document data is stored in accordance with one embodiment.

FIG. 18 is a block diagram of the architecture for a portion of a document management system, which, by utilizing dynamically generated webpage content (e.g., using Perl, Active Server Pages, PHP, JavaScript, JSP, JAVA, or any other suitable server side processed language), can link and retrieve at least one document via a search mechanism in accordance with one embodiment.

FIG. 19 is a block diagram of a portion of a document management system's search results in which a viewer can see: a) the image of the document; b) the text file of the scanned document; and c) ALL the documents that are located in the same folder in which the original search result ‘hit’ was discovered in accordance with one embodiment.

### DETAILED DESCRIPTION

In various embodiments, one or more documents are automatically scanned, the text data is automatically extracted from the scanned image (if necessary), the scanned image is automatically optimized (if necessary), the optimized image and the text data are automatically transmitted to a server, the text data is automatically indexed, and the text data and optimized image are automatically made available on the server. Further, in various embodiments, the above automated actions are performed as a substantially continuous automated action substantially without manual interruption; however, it should be appreciated that any one or more of the actions can be configured as manual process.

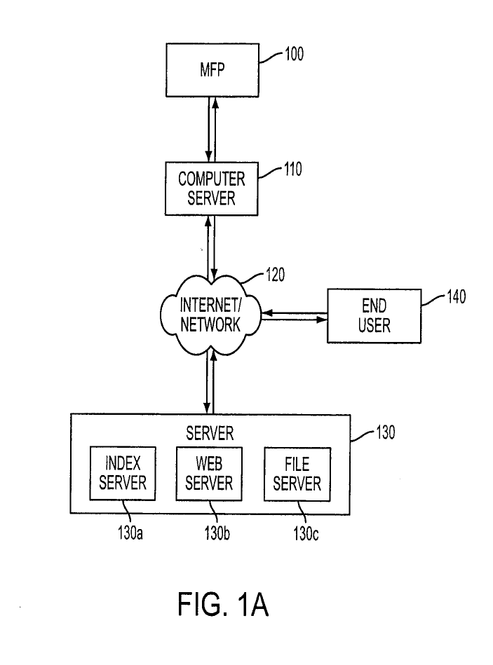

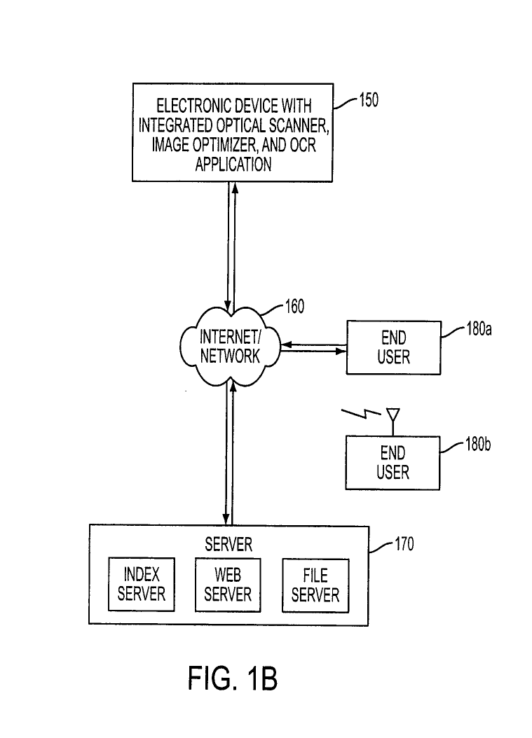

FIG. 1A illustrates a system in accordance with one embodiment. An MFP 100 is provided. The MFP 100 is coupled to a computer 110 (e.g., a server or computer). In this embodiment, at least one document is scanned at the MFP 100 resulting in an image file. In one embodiment, the resulting image file may or may not be saved at the MFP 100 (e.g., the image may reside in temporary or long term memory in the MFP 100 like RAM, FLASH, HDD, etc.). The MFP 100 transmits the resulting image to the coupled computer 110, wherein the resulting image may or may not be saved at the coupled computer 110 (e.g., stored in temporary or long term memory). The computer 110 extracts any detected text data from the image file and the image is optimized (e.g., resized) at the dedicated computer 110. The computer 110 transmits (e.g., uploads) the optimized image and the text file through a network 120 (e.g., a LAN or the Internet) to at least one server 130. In one embodiment, the server 130 may be a single electronic device that includes all of the functions of an index server 130a, web server 130b, and a file server 130c; however, it should be appreciated that the server 130 can be a secure server farm that includes a plurality of separate, network connected electronic devices that perform the functions of an index server, web server, a file server, and any other suitable server function. Server 130 indexes, stores in folders, and makes the image file and text file accessible over a network. Server 130 enables at least one end user 140 to access the image file and text file through a network (e.g., through a web browser based application or any other suitable front-end software application).

FIG. 1B illustrates a system in accordance with one alternative embodiment. An electronic device 150 is provided. In one embodiment, the electronic device 150 includes all of the functions of the MFP 100 and computer 110 described above. That is, the electronic device 150 can be configured with at least one optical scanner, at least one image optimizer hardware circuitry or software program, at least one OCR software program, communication capabilities, storage, and any other hardware necessary to carry out the functions of the MFP 100 and the computer 110. It should be appreciated that electronic device 150 can be configured to include any other suitable hardware and software function necessary to implement the document management system. As illustrated in FIG. 1B, the electronic device 150 is coupled to a network 160 (e.g., such as the Internet; however it should be appreciated that the network could simply include a LAN). Electronic device 150 is also coupled to or in communication with a server 170 through the network 160. Electronic device 150 is configured to transmit at least one optimized image file and at least one text file of at least one scanned document to the server 170. As above, server 170 can be configured as a single electronic device or multiple devices that include all of the functions of an index server, web server, a file server, and any other suitable server functions. Server 170 indexes, stores in folders, and makes the at least one image file and at least one text file accessible over a network. Server 170 enables at least one end user 180a to access the image file and text file through a network (e.g., through a web browser based application or any other suitable front-end software application). It should be appreciated that server 170 can be configured to enable any suitable number of end users to access the stored files. In one embodiment, end users 180 can connect through any suitable network connection such as end user 180a accessing server 170 through a hardwired connection (e.g., POTS, Ethernet, Fiber, DSL, etc.), while end user 180b accesses server 170 through a wireless connection (e.g., through WIFI, cellular, satellite, etc.).

In one embodiment, a user places documents in an automatic feeder of an MFP; however, it should be noted that the documents can be placed in any suitable location at the MFP that can accept documents for scanning. It should also be appreciated that the MFP can scan any other suitable item (any item that can be scanned will hereinafter be referred to as a document). Preferably, the process is advanced (e.g., a mode of the MFP corresponding to the process is selected) once a button is pressed on a touch screen of the MFP (e.g., the touch screen of the MFP used to select various options such as printing, copying, etc.); however, any suitable input device can be used to advance the process or, alternatively, a sensor senses the presence of the documents on the feeder or other suitable location and automatically advances the process.

In one embodiment, once the mode corresponding to the process is selected, a user is prompted to enter an identifier for the one or more documents and/or files the user wishes to scan into the system, which includes a web site running on a secure server farm. However, it should be noted, the user can be prompted at any suitable time or not prompted at all (e.g., an identifier can be automatically assigned). Further, the system can include any suitable server configuration using any suitable communications and/or information accessing protocols.

In one embodiment, a NEXT button or any other suitable input device on the MFP is pressed and the documents are scanned at a predetermined rate or a rate determined by the user (e.g., a rate of 35 and 50 pages per minute or any other suitable rate). It should be noted that in various embodiments, it is unnecessary for a user to enter further input before scanning begins. For example, in one embodiment, the MFP automatically assigns an identifier and scanning begins automatically.

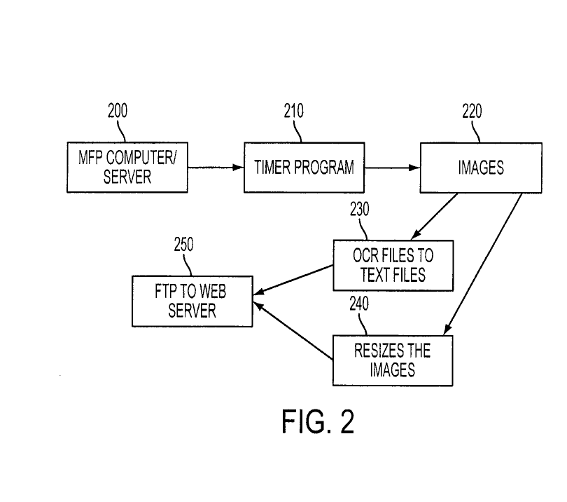

FIG. 2 illustrates one subroutine of the document management system that is conducted in at least one MFP Server, wherein the MFP is configured to generate a folder on a coupled MFP Server (e.g., any suitable computer or server) at block 200 with the folder name; however, the folder can be created in any suitable location and can have any suitable name (e.g., if the storage device on the computer is a hard drive, the folder is created on the hard drive; however the storage device can be any suitable storage device, such as, but not limited to, a solid state drive, a tape drive, an optical drive, or a network attached storage device). In one embodiment, the scanned images are saved as a JPEG file in this new folder; however, the images can be saved in any suitable format. Further, in one embodiment, the system follows a naming convention for the saved files. For example, if the identifier for the folder is “test folder,” a scanned image file is named in accordance with the following naming convention:

testfolder_year_month_day_hour_minute_second_page#jpg.

However, it should be appreciated that any suitable naming convention can be used.

In one embodiment, the touch screen resets back to the beginning; however, the touch screen is not required to reset. In one embodiment, the MFP is a commercial off the shelf multi-function printer that has scanning capabilities. The MFP can be modified to operate with the above-described document management system. For example, the MFP can be configured with additional software and/or hardware features that enable the MFP to function in the document management system for a minimum cost. In one example, the MFP can be a modified Lexmark MFP; however, any suitable MFP or single purpose scanner can be used. It should be appreciated that the MFP can also be configured as specialized/dedicated electronic device that functions solely with the above-described document management system. In one embodiment, the above transpires at or within the MFP; however, the above can transpire at or within any suitable device or location.

In one embodiment, the MFP Server coupled to the MFP continually polls a connected storage device (e.g, once every 20 seconds or any other suitable period of time) to determine whether the MFP has deposited at least one image file for processing and uploading. In one embodiment, the MFP server continually polls the connected storage device using a timer application/program as illustrated at block 210. In one such embodiment, the timer application that initiates one or more of the processes described below within the MFP Server is written in Microsoft Visual Basic; however, the timer application can be written in any suitable language (C, C++, Perl, Python, etc. . . . ) or can be embodied in dedicated electronic circuitry. Further, it should be noted that the timer application can check according to any suitable schedule, including schedules that only allow for checking when the system is otherwise idle. However, it should be understood that the MFP Server can be installed in any suitable manner and can poll any suitable storage device for any suitable information in accordance with any suitable schedule. It should further be appreciated that the timer program can reside on a machine other than the MFP Server.

In one embodiment, if the MFP Server detects an image file (e.g., a JPEG file) as illustrated at block 220, the MFP Server determines if the at least one image file includes text and if the file needs to be optimized.

In one embodiment, if the MFP Server determines that the image file includes text, the MFP Server is configured to process the image file, extract any detected text with at least one OCR program, and create a file that includes the detected text (e.g., a text file such as a .txt or .rtf file or any other suitable file) as illustrated in block 230. In one embodiment, the MFP Server includes a Software Development Kit (SDK) such as SimpleOCR that can be configured to perform the OCR; however, it should be appreciated that the OCR can be performed in any suitable manner using any suitable device, software, and/or algorithms. It should also be noted that the OCR program can be utilized for recognizing English and non-English languages. As a result, in various embodiments, documents including non-Latin based languages (e.g. Arabic, Chinese, etc. . . . ) can also be scanned and processed with OCR automatically. Further, documents including a mix of Latin based languages and non-Latin based languages can be scanned, processed with OCR automatically in various embodiments. In one alternative embodiment, one OCR program can process an image in multiple languages; however, it should be appreciated that the MFP Server can include a plurality of different OCR programs that can be employed in a parallel or sequential manner to create a text file.

In one embodiment, if the MFP Server determines that the image file is not optimized, the MFP Server is configured to process the image file to optimize the image as illustrated in block 240. In one embodiment, the MFP Server resizes the originally scanned image file and creates a new image file (e.g., a compressed image file such as a JPEG file). Preferably, the image file is resized such that it can be easily displayed in a Web browser or a word processing document without further resizing by the browser or word processor. In one embodiment, the MFP Server uses a software application (e.g., ASPJPEG) to resize the image, but any suitable software application, device, or algorithm can be used. In one such embodiment, the image optimization includes resizing the image to 600 pixels wide while maintaining the aspect ratio so that the height is adjusted to the correct size while substantially maintaining the quality of the image; however, the image can be resized to any size in any suitable manner. The DPI is preferably adjusted to 200; however, the DPI is not required to be adjusted. It should be noted that the pixel size and DPI of the optimized image can be configured for any suitable size and that it is not required that the height to width ratio be substantially maintained.

In one embodiment, the DPI of the resized image is determined based upon the character type of text present in the image. For example, an image including only Latin characters might be resized with a DPI of 200, while an image including Arabic characters might be resized with a DPI of 300. It should be appreciated that any character set can be associated with any suitable DPI. In one embodiment, an image including only a subset of Latin characters that are capable of being clearly displayed at a lower (e.g., 150) DPI is resized with a DPI of 150. In one embodiment, a user specifies which language or languages are present in the document and the DPI is adjusted accordingly. In another embodiment, the system automatically detects which characters or character sets are present and adjusts the DPI accordingly. As a result, the system is able to resize the image without substantial reduction in the quality of the textual portions of the image. In still another embodiment, an image is resized using a format which enables portions of the image to have different DPI. Higher DPIs are used preferably only in the regions defined automatically or by the user to require higher DPI.

It should also be appreciated as shown in FIG. 2, the MFP Server can perform the text extraction and image optimization in substantially parallel processes; however, the MFP Server can perform the text extraction and image optimization in sequential processes or in any suitable order. It should further be appreciated that the MFP Server can be configured as more than one electronic device. In one such embodiment, the MFP Server that performs the OCR is a first electronic device and the MFP Server that performs the image optimization is a second electronic device. In an alternative embodiment, if volume of document scanning necessitates it, the MFP Server can be configured as a load balancing server that uses a plurality of different computers/server to perform the OCR and image optimization (e.g., through distributed or parallel computing).

In one embodiment, the MFP Server can be configured to generate a thumbnail image from the original image or optimized image using any suitable software. The thumbnail image reduces the size of an image included in a Web page to cause a corresponding decrease in the amount of data that must be downloaded by the user for viewing the image. A thumbnail image created from an original image typically conveys sufficient information so that a person viewing the thumbnail image is aware of the content of the original image. Thus, Web pages that display thumbnail images instead of full size images download more quickly and still communicate the intended expression of the document/image to the user.

In one embodiment, the MFP Server can be configured to generate a PDF file of any one of the image or text files described above using any suitable PDF conversion program. Converting a file to PDF is used to produce smaller file sizes and/or to produce standard image output that maintains a documents layout across different computers and different PDF viewers. The MFP Server can generate the PDF file according to any predetermined or user selected options in third party applications, or according to exposed API (application programming interface) parameters in the third party applications used to create the PDF file.

In various embodiments, file attributes (e.g., metadata) can be created for each of above described files. In one embodiment, the metadata for each file includes, but is not limited to information such as, who created the file, when and where the file was created, and what programs were used to create the file. Preferably, any metadata associated with a file is automatically generated when the file is created. In one embodiment, the system can be configured to enable the user to generate or edit a file's metadata before it is created. However, when the system is automated, the system can enable user generated metadata associated with one or more of the files to be added and/or edited at a later point in the system as discussed below.

In one embodiment, the generated files described above (e.g., the generated text file, the optimized image file, etc.) are transmitted to a web server (e.g., via FTP or any other suitable data transfer protocol). In one embodiment, the web server is a single server, however, the web server can be configured to include a plurality of servers in a secure server farm/co-location facility. It should be noted that the files can be transmitted to any suitable location or any suitable device, using any suitable transmission protocol. In one embodiment, the different files can be transmitted to different devices if desired (e.g., different servers in the same or different server farm). In one alternative embodiment, it should be appreciated that the MFP Server can serve as a web server, whereby the files would not need to be transmitted to a separate server.

In one embodiment, the MFP Server transmits each generated file individually as needed. In one alternative embodiment, the MFP Server transmits associated files as a group of files in folders, in compressed or uncompressed archives (e.g., as ZIP, TAR, SIT, DMG) or any other suitable format. However, it should be appreciated that files can be transmitted in any suitable manner at any suitable time.

In one embodiment, the MFP Server follows a naming convention for the files being transmitted and saved in the Secure Server Farm. For example, if the identifier for the folder is “test folder”, the transmitted image file and the text file are saved in the folder in at least one server located in the secure server farm in accordance with the following naming convention:

testfolder_year_month_day_hour_minute_second_page#.jpg

testfolder_year_month_day_hour_minute_second_page#.txt,

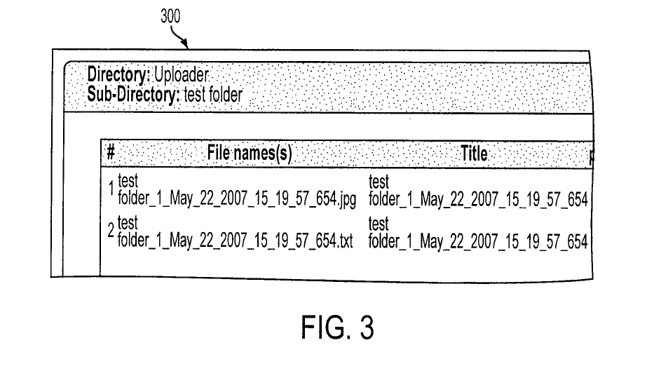

as shown in the section of display screen 300 of FIG. 3. However, it should be appreciated that any suitable naming convention can be used.

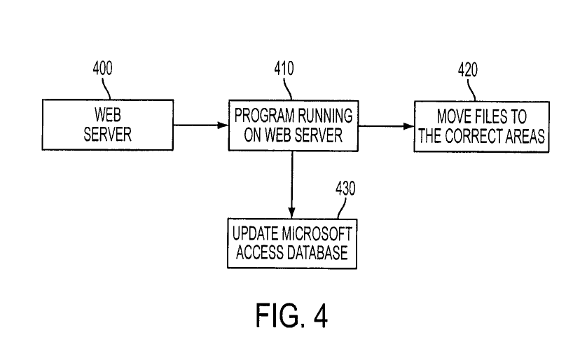

FIG. 4 illustrates one subroutine of the document management system that is conducted in at least one server in block 400 within a Secure Server Farm of a system of one embodiment. In one embodiment as illustrated in block 410, at least one software application running on at least one server at the Secure Server Farm examines an electronic file repository every 20 seconds (or any suitable period of time) to determine if the MFP Server uploaded new files (e.g., the text file, optimized file, etc.). It should be noted that the mechanism used to check for newly uploaded or modified files can be software written in any suitable programming language or can be embodied in dedicated circuitry. In this embodiment as illustrated in block 420, if any new folders and/or files are present, the software application causes the new folders and/or the files to move to appropriate system folders on at least one server in the Secure Server Farm. As illustrated in block 430, the software application also causes any metadata associated with the files and any detected text files to be indexed in at least one server (e.g., capture the folder and/or file names and properties), wherein the results of the indexing process are saved into a database (e.g., a relational database such as MS Access, MS SQL Server, Oracle, or any other suitable database system). It should also be appreciated that the indexing process can capture at least part of or all of the contents of in the text file. In one embodiment, once the documents are indexed and saved in the appropriate folders, they are resident on the secure server farm and ready for searching, viewing, sharing or any other suitable activity.

Furthermore, when the timer software application is finished, the timer software application preferably cycles to a waiting mode and checks again in 20 seconds for more files and/or folders; however, as described above, the timer program can check for new files and/or folders in accordance with any suitable schedule (e.g., before, during, or after the file moves and indexing is completed).

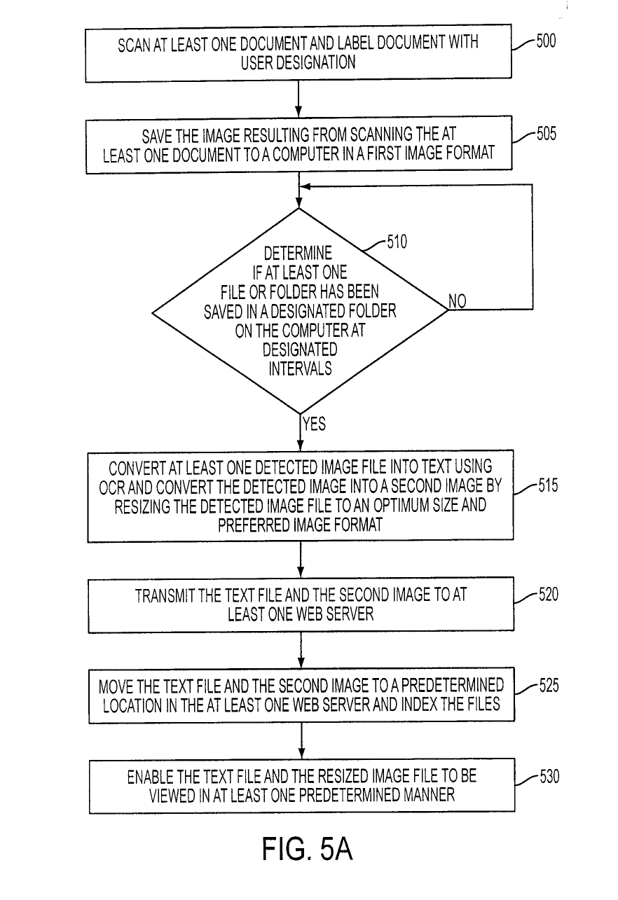

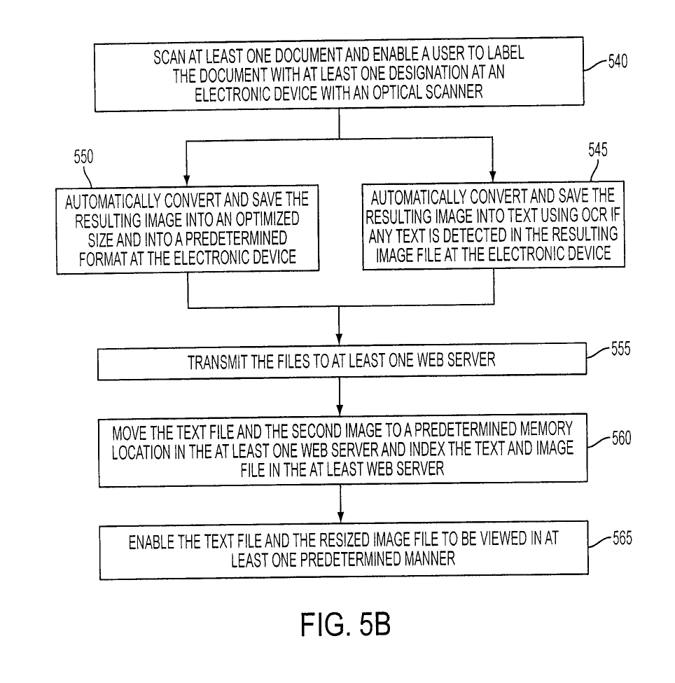

FIG. 5A illustrates a process of automatically uploading documents in accordance with one embodiment. At block 500, an MFP scans the hard-copy documents and enables a user to label the documents with a folder name that a user enters via the MFP display panel (it should be appreciated that the MFP can automatically assign a name as discussed above). At block 505, the scanned images are saved to an MFP Server in a predetermined image format. At block 510, a timer program determines if any scanned files have been placed in a designated folder of the MFP Server. If no files have been detected, the timer program waits the predetermined amount of time and the process repeats at step 510. If there are new files, at block 515, the new files are processed (e.g. with OCR and to optimize the image). At block 520, the files are transmitted to at least one secure web server. At block 525, at least one program moves the files to at least one predetermined location (in the web server or else where) and indexes any metadata associated with the files and the text content of any text files in at least one predetermined database. At block 530, the process includes enabling the files to be viewed in at least one predetermined manner. In various embodiments, it takes approximately less than 1 minute for a document scanned by the process illustrated in FIG. 5A to be ready for viewing; however, the process can take any suitable amount of time. It should be noted that in various embodiments, accuracy of the OCR process is not verified until the files are uploaded to the secure server, if ever.

FIG. 5B illustrates a process of automatically uploading documents in accordance with one embodiment. At block 540, a scanning device scans the hard-copy documents and enables a user to label the documents with a folder name that a user enters via a display panel on the scanning device (it should be appreciated that the scanning device can automatically assign a name for the folder as discussed above). At block 545, the scanning device automatically converts the scanned images into at least one text file using OCR if any text is detected in the scanned images. At block 550, the scanning device automatically converts the scanned images into an optimized image in a predetermined format (e.g., in the JPEG format) if necessary. At block 555, the scanning device transmits the files to a secure web server. At block 560, a program moves the files to the correct areas (i.e., in the secure web server or to different servers) and indexes the files into a database (i.e., any metadata associated with the files are indexed as well as the contents of the text file). At block 565, the process enables the files to be searched, viewed, and/or otherwise manipulated (e.g., in a web browser or other suitable browsing application). In one embodiment, the text file can be viewed to enable manual correction of OCR errors. In one embodiment, the process also enables a user to add or edit metadata to the files. In various embodiments, it takes approximately less than 1 minute for a document scanned by the process illustrated in FIG. 5B to be ready for viewing; however, the process can take any suitable amount of time. It should be noted that in various embodiments, accuracy of the OCR process is not verified until the files are uploaded to the secure server, if ever.

In one embodiment, scanned input from an MFP (e.g., the scanned documents or items) is transmitted to the Secure Server Farm as described above. In one embodiment, this input, stored in a suitable file format (e.g., TIFF/JPEG), is processed with OCR and optimized, and the results are saved preferably before uploading; however, it should be appreciated that any processing (e.g., with OCR, optimization, etc.) can be performed after uploading to the Secure Server Farm. In one embodiment, the OCR results can also be edited and saved after the files are uploaded.

In various embodiments, the document management system enables a user to access and manage files stored at the secure server farm via the Internet or any other suitable computer network. The user logs in and is provided with an interface for managing the user's files. Management activities include sharing the files with other users, editing the files, moving the files to different folders, associating or disassociating files with other files, printing files, displaying files, setting access privileges to files, e-mailing or otherwise transmitting files, adding information to and/or annotating files, and/or deleting files. In one embodiment, the interface utilizes drag and drop techniques, pop-up menus and/or any other suitable windowing interface features. In one embodiment, a user can access and manipulate one or more files remotely (e.g., via the Internet using a web browser), without first transmitting a full copy of the file to the user's computer. In another embodiment, a user can access an manipulate one or more files remotely through a desktop software application. In alternative embodiment, a user can access one or more files through both a web browser based software application and a desktop software application.

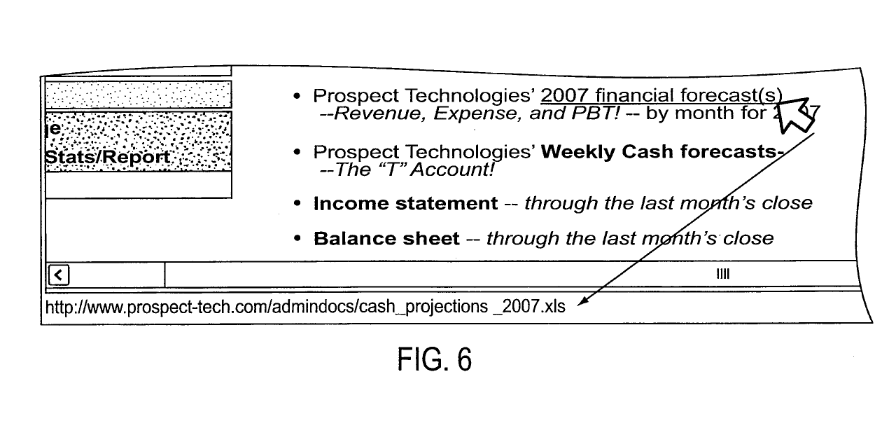

In one embodiment, wherein a user accesses files remotely through a web browser, security of the document management system is improved by hiding the Uniform Resource Locator (URL) associated with an active link (e.g., a hyperlink) on a web page. Web browsers often have the ability to display the location of an active link when a computer cursor is placed above an active link (i.e., a mouse-over action), as shown in FIG. 6, which illustrates this feature in a normal hyper-linked Web page. In one embodiment, the system has special code that prevents the user from seeing the stored location of the document in the system. In one embodiment, hiding the mouse-over information is accomplished using Javascript code embedded in the Web page code; however, the feature can be accomplished in any suitable manner using any suitable programming language. For example, the code can include the following:

<Script Language=JavaScript Type=“Text/JavaScript”>
function hidestatus( ){
window.status=“
return true
}
if (document.layers)
document.captureEvents(Event.MOUSEOVER | Event.MOUSEOUT)
document.onmouseover=hidestatus
document.onmouseout=hidestatus
</script>

The above code helps to protect the files and their location. Specifically, if a user cannot see a URL of the files, it becomes more difficult to hack into an unknown location. Not only would a user need to defeat any other security the system has, the user would also need to correctly guess the address of the file to which he or she is attempting to gain unauthorized access.

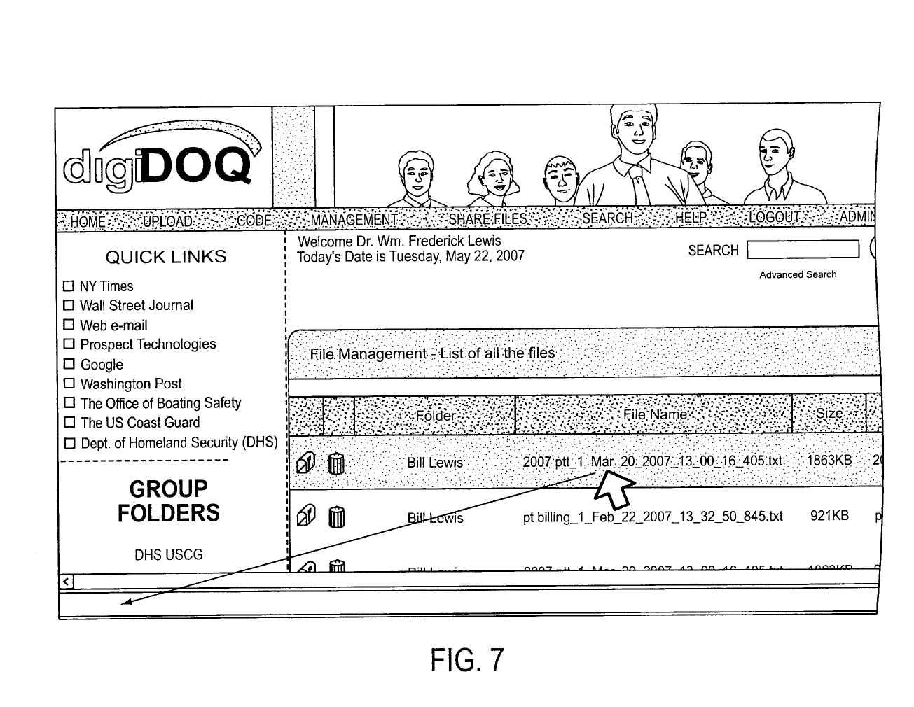

In accordance with one embodiment as illustrated in FIG. 7, when the computer cursor is moved over a hyper-link in a web page of the document management system, the location of the file is not displayed.

In one embodiment, wherein thumbnail images are generated for an optimized image, when the computer cursor is moved over a hyper-link in a web page (i.e., a mouse-over action) of the document management system, a thumbnail image is displayed for a predetermined period of time or until the computer cursor is moved away from the hyper-link (i.e., a mouse-out action). This enables a user to obtain a quick view of a document without the need to download the entire document. In one embodiment, the thumbnail image is displayed in the same display window as the web page and hyper-link when a mouse-over action occurs (e.g., though cascading style sheets and javascript, or through any other suitable manner), whereas the thumbnail image is removed from the display when a mouse-out action occurs. In an alternative embodiment, the thumbnail image is displayed in a new window when a mouse-over action occurs, wherein the window is closed when the mouse-out action occurs. It should be appreciated that any suitable method can be used to display a thumbnail image.

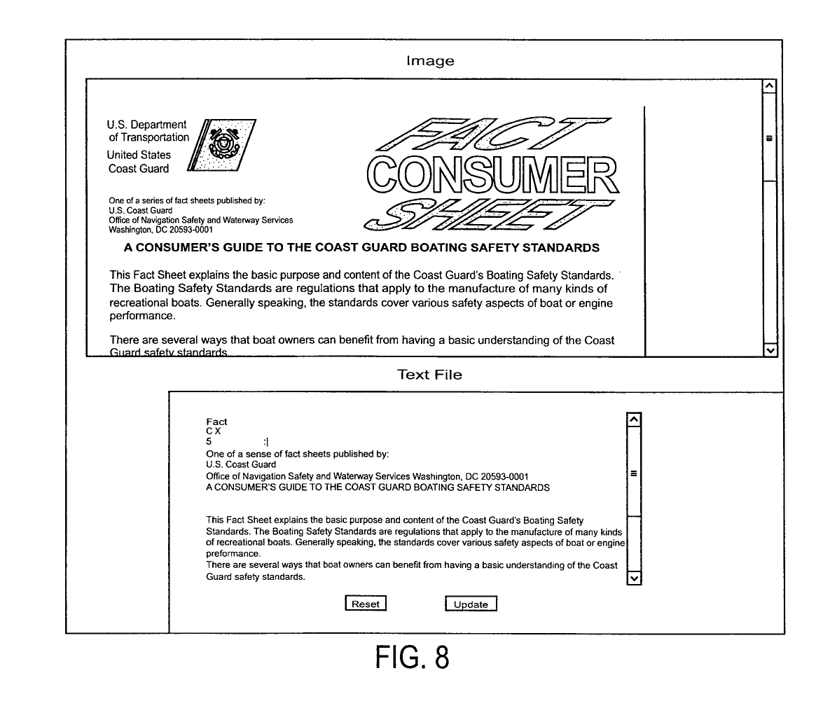

In accordance with one embodiment shown in FIG. 8, an interface displays both the optimized image file and the contents of the file. Displaying both files together enables a user to more easily detect and correct any OCR result errors that may occur. In one embodiment, a web browser loads a webpage containing the scanned image and the text file corresponding to the optimized image. In one embodiment, the optimized image and text can be loaded in separate frames on in a single web page (e.g., one for the image and one for the text file). This type of web page layout is called an Iframe (Inline Frame). The optimized image is in the top frame and the text file is on the bottom frame; however, the frames can be configured in any suitable arrangement. By simply imbedding the .txt file in a <input type=“textarea”> command for HTML, it is possible to edit this information; however, the text can be edited using any suitable interface in any suitable manner. However, it should be appreciated any suitable type of web page layout can be utilized and frames are not required in various embodiments (e.g., the web page interface can be configured with CSS). In an alternative embodiment, the optimized image and text can be loaded in separate web pages for review and/or editing. In another embodiment, information can be copied and pasted from one or more other applications. In still a further embodiment, a network enabled desktop software application can be configured to display the file, enable editing, and perform any other suitable function of the document management system.

In one embodiment, when the contents of the text file is loaded into a web page from a web server, all the information is read from the text file and all of the information is displayed in the text area of the web page. However, in other embodiments, only a portion of the contents of the text file (e.g., a portion corresponding to a portion of the image file to be concurrently displayed) is placed in the text area. In one embodiment, the document management system is configured with a parsing application such as MS ASP 3.0 as the backend web page parsing engine to enable retrieval of the information from a file and generate a web page display of the information; however, in various embodiments, any suitable dynamic parsing system can be used to deliver dynamic web page content.

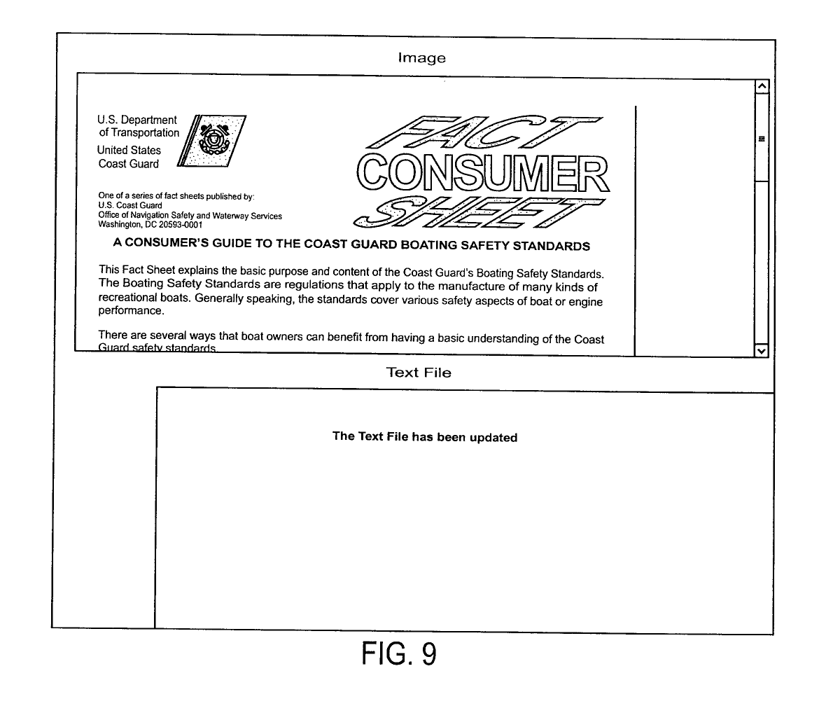

In one embodiment as illustrated in FIG. 8, wherein the user added or edited the content of the text file, when the user clicks the update button, the document management system updates the contents of the text file and the content stored in the indexed database. In one embodiment, if the document management system uses a web page, the system uses the “request.form”, any underlying file system IO calls, and/or SQL calls to save the updated text content back to the file-location and index database. When the process is completed, another page is returned indicating that the new or updated information is saved. For example a response page is displayed inside the text area, as shown in FIG. 9.

In one embodiment, the system employs a permissions system. The permission system enables a user to restrict access to one or more files (i.e., prevents other users from accessing certain files). File permission's can be set such that certain files are only accessible by users having permission to access the files. For example, if a company scans a document into the document management system containing sensitive employment information, file permissions can be set on the file that restricts access to the file to only members of the company's human resources department. On the other hand, if the company scans a document in the document management system containing non-sensitive marketing material, file permissions can be set on the file giving access to all members of the company. It should be appreciated that any suitable level of file permission detail can be set for a file in the document management system (e.g., access by certain users or groups of users, by time, read/write access, etc.). It should also be appreciated that the file permissions can affect the system's text search capability. That is, if a file is marked private or other suitable file permission restrictions are associated with a file, the file is off-limits and can be excluded from a search.

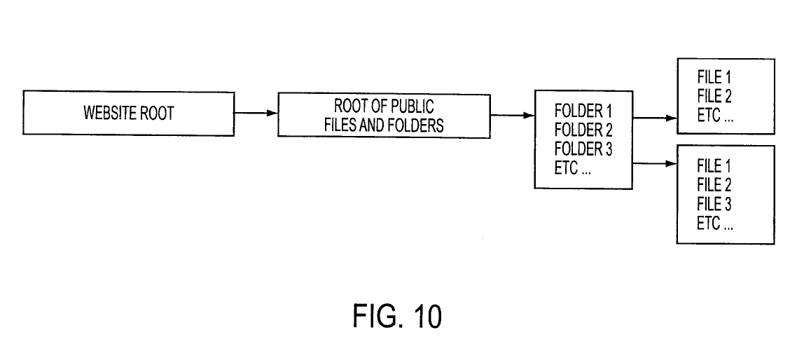

In one embodiment, files can be excluded from searches by creating two types of folders areas, specifically a public area and a private area. The pubic area is preferably a folder configured off of the root of the web site file directory; however, the public area can be any suitable area at any suitable location on any suitable server. As shown in FIG. 10, the public area can have a plurality of sub-folders under the public folder. Preferably, a security mechanism is provided to check whether a user has access to the publicly stored files; however, such a mechanism is not required.

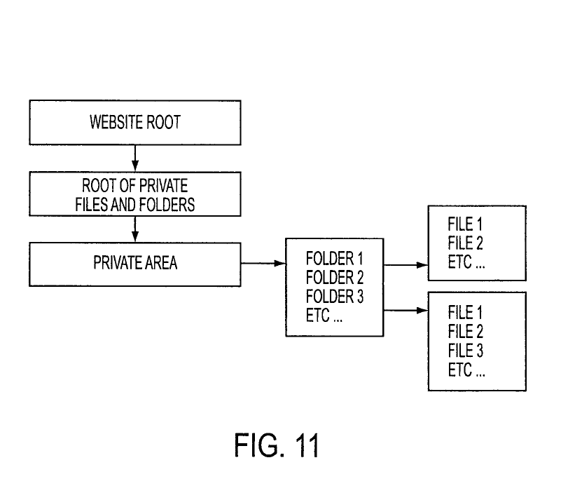

Preferably, each user is associated with his or her own private folder area. As shown in FIG. 11, the private folder area is configured off of the main root of the web site file directory; however, the private folder area can be configured in any suitable area at any suitable location on any suitable server. Preferably, a security mechanism is provided to check whether the user has access to the private stored files (e.g., through a user name/password, biometric access, public key infrastructure, or any other suitable security mechanism).

In one embodiment, an index server (e.g., Microsoft Index Server) separately indexes files and folders in the Public and Private areas; however, indexing can be performed by any suitable device or software and in any suitable manner. An index server indexes files (e.g., opens the files, retrieves and analyzes the contents, and stores the results in a database) that are placed on one or more servers. It should be appreciated as described above, the indexing process can be configured to capture any metadata associated with the files or folders. In one embodiment, the system controls which files are indexed by selecting the folders for which indexing is desired (i.e., a Catalog). Preferably, when a new file is placed on the server it is indexed in accordance with indexing schemes described above or any other suitable indexing schemes. Further, if a file changes, the system preferably also re-indexes the file; however, re-indexing is not required. Preferably, a Catalog of the folders desired to be indexed is created. Further, the number of characters to display in the search results (summary/abstract), how much drive space is needed and what to exclude if necessary is specified.

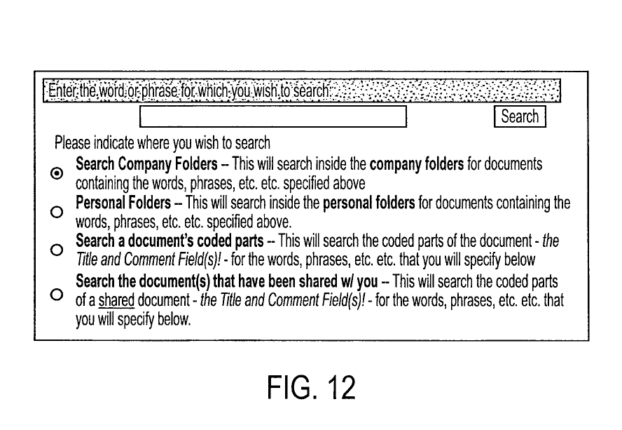

Further, in one embodiment, each private area, specific to different users, can be indexed separately. As such, file permissions associated with files can also be associated and inherited with the indexed data. In another embodiment, the collection of files to which a user has access is indexed separately. In still another embodiment, the collection of private files to which a user has access is indexed separately. FIG. 12 illustrates a search interface in which a user is asked the file locations that the user desires to search.

FIG. 12 also illustrates a search interface that enables a user to enter search terms. The search interface is connected to a search engine designed to search for indexed information in the document management system. In one embodiment, the search engine operates by enabling a user to enter search terms and comparing the search terms at least to indexed data. In one embodiment, when a user enters a search query into a search engine, the search engine uses the Boolean operators AND, OR and NOT to further specify the search query. The search engine can also be configured with advanced features called proximity search which enables the user to define the distance between keywords; however, it should be appreciated that any suitable search system can be incorporated with the search engine. In one embodiment, if a match is found between the user's search term and the indexed data, the search engine returns a summary of the matching information (e.g., the document's title and/or parts of the text, wherein the summary could be a computer generated summary or a human generated summary). In another embodiment, when the search engine returns a search result, but before the result is displayed, the search engine determines whether a search word or phrase is present in the summary/abstract, metadata, or text contents. If so, the word or phrase is highlighted when displayed to the user.

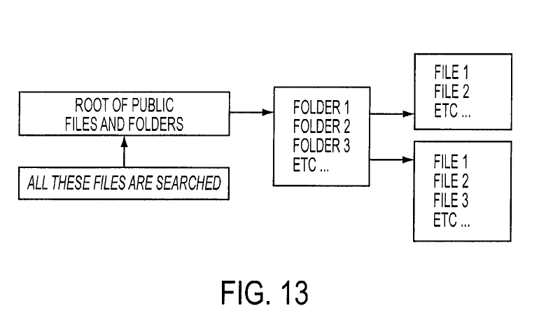

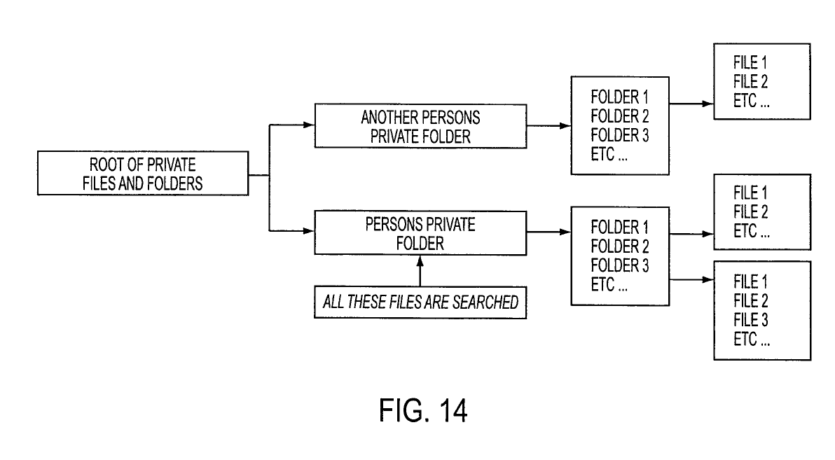

In one embodiment, the scope of a search that includes the public area includes everything in and hierarchically within the main public folder, as shown in FIG. 13. In contrast, the scope of a search that includes a user's private area includes the private folders for a user and not any of the private folders for another user, as shown in FIG. 14.

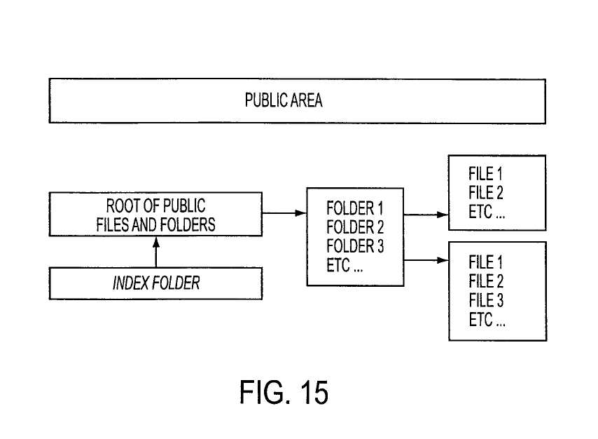

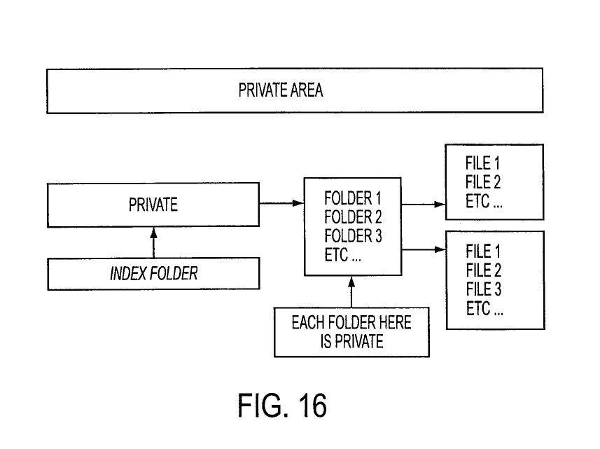

FIG. 15 illustrates indexing public files in accordance with one embodiment. Similarly, FIG. 16 illustrates indexing private files in accordance with one embodiment. All of the folders are indexed; however, each folder is a private folder and only these private files (to which the user executing a search has access) are searched.

In one embodiment wherein a user executes a search, the one component of the system (e.g., the search engine) performs a check on the files in the index database, finds the record in the index database, and then generates a link to that record; however, it should be appreciated that these tasks can be split among any suitable number of different software applications to form the end search result. In one embodiment, when the system generates a search result, a link to another web page that is associated with the index number is created. The web page associated with the index number can be configured to display information such as a list of other files that are in the same folder (this is helpful in the case where documents in the same folder contain related subject matter). As a result, the user executing a search is lead to additional files that may have been missed by the initial search, but are relevant to the user's search/task. It should be appreciated, however, that indexing and/or searching of documents in the system can be accomplished in any suitable manner.

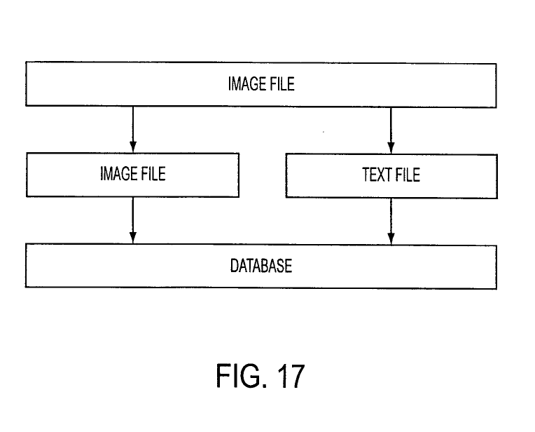

One of the draw-backs of many imaging systems is the inability of the system to search images of documents for words, text or phrases. Various embodiments, however, as described above, have an efficient mechanism for indexing and searching one or more images. Specifically, in accordance with various embodiments, an image that contains text is processed with OCR and the information is saved in a text file. The optimized image (preferably resized, though resizing is not necessary) and the resulting text file are uploaded and the folder, image and text file names are saved in a database, as shown in FIG. 17.

In this embodiment, the files are placed in folders that are indexed by an index server (e.g., Microsoft Index Server). A Catalog is created in the index server that has the folders to index, what to exclude from the search, how large of an abstract to be created, metadata, and/or any other suitable information. Any files placed in these folders are indexed. Any changes to the files will cause the files to be re-indexed.

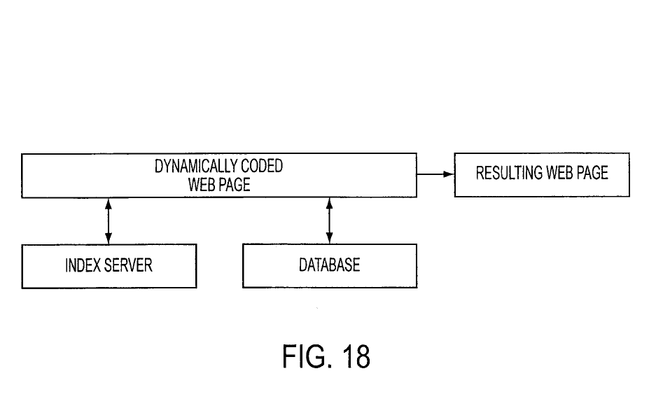

The architecture for the portion of a system used to create the links as search results in accordance with one embodiment is illustrated in FIG. 18. Preferably, when the document management system retrieves the information from the index server (e.g., though a web page request or an alternative system component request based a user's search) and before the results are displayed, a search in a database (e.g., Microsoft Access Database) for the folder(s) and file name is performed to search for other stored files related to the search results. If any results of related files are found in the database, a link is generated for each associated file; however, the above actions can occur at any time and/or are not required. In one embodiment, three links are generated for each matching search result. However, more or less than three links can be generated and displayed. In this embodiment, the three links include a link to the optimized image file, a link to the text file, and a link to the folder that contains both the image and text file. In one embodiment, if no link in the database is found, then just the link to the file the document management system found in the index server is made. In another embodiment, if the image is one page of a larger document (e.g., a multiple page document or one section of a very large single document), one or more links can be provided to the other pages or sections of the document.

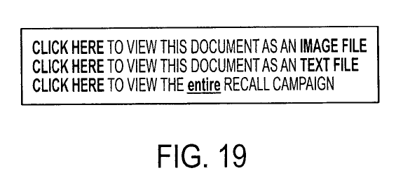

FIG. 19 illustrates a search result display when an image file is found in accordance with one embodiment. The Microsoft Access database results are based upon the text file that the index server returned in this embodiment; however, other embodiments can operate in any suitable manner. Links to the image and text versions of the image are provided as well as a link to the rest of the folder in which the documents reside.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of storing document data comprising:
scanning at least one document to produce at least one image file;
optimizing the at least one image file to produce an optimized image file;
extracting text data from the at least one image file or the resized image file to produce a text file;
transmitting the text file and optimized image file to at least one server;
indexing the text file and optimized image file in the at least one server; and
making the text file and optimized image file accessible via a network, wherein scanning, resizing, extracting, uploading, indexing and making are performed substantially automatically.

2. The method of claim 1, further comprising generating a thumbnail image file from the optimized image file and making the thumbnail image accessible through the network.

3. The method of claim 1, further comprising generating a PDF from the optimized image file and making the PDF accessible through the network.

4. The method of claim 1, wherein the indexing further comprises capturing metadata from file attributes from each of the transmitted files and capturing at least part of the text data from the text file.

5. The method of claim 1, further comprising enabling a user to add and edit metadata associated with at least one of the files.

6. The method of claim 1, wherein making the text file and optimized image file accessible through a network includes enabling a user to execute a search for at least one of the files based on user defined search terms.

7. The method of claim 6, wherein making the text file and optimized image file accessible through a network includes enabling the user to edit the contents of the text file and save the changes to the text file while comparing the contents of the text file to the optimized image file.

8. The method of claim 1, wherein optimizing the at least one image file further includes resizing the image to a predetermined width such that the image can be displayed and printed without further resizing the image.

9. The method of claim 1, wherein at least one of the files is accessible through a web browser.

10. The method of claim 1, further comprising generating an optimized image file and a text file for each scanned document.

11. A system for storing document data comprising:
at least one scanning device; and
at least one server;
wherein the at least one scanning device is in communication with the at least one server and are operable to automatically:
(a) a scan at least one item and generate at least one original image file;
(b) generate a text file from the original image file using optical character recognition if any text is detected in the original image file;
(c) generate an optimized image file from the original image file;
(d) index at least part of the contents of the text file and any metadata associated with the text file and the optimized image file;
(e) enable the text file and optimized image file to be accessible through a network.

12. The system of claim 11, wherein the at least one scanning device and the at least one server are in communication through a network.

13. The system of claim 12, wherein the network is the Internet.

14. The system of claim 11, wherein the at least one scanning device and the at least one server are directed coupled.

15. The system of claim 11, wherein the text file and optimized image file are accessible through a network by enabling a user to execute a search for at least one of the files based on user defined search terms through a web based search.

16. The system of claim 11, wherein a user is enabled to add and edit metadata associated with at least one of the files.

17. The system of claim 16, wherein the text file and optimized image file are made accessible through a network for viewing simultaneously.

18. The system of claim 17, wherein the text file and optimized image file are viewed simultaneously in a web browser.

19. The system of claim 17, further comprising enabling a user to edit the contents of the text file and save the changes to the text file while comparing the contents of the text file to the optimized image file.

20. A system for storing document data comprising:
a scanning device configured to scan at least one item and create at least one original image file;
a processing device coupled to the scanning device, wherein the processing device is configured, for each scanned item, to:
(a) receive at least one original image file,
(b) generate a text file from the original image file using optical character recognition if any text is detected in the original image file,
(c) generate an optimized image file from the original image file, and
(d) transmit the text file and the optimized image file;
a server coupled to the processing device, wherein the server is configured to:
(a) receive the text file and the optimized image file,
(b) index the contents of the text file and any file metadata associated with the text file and the optimized image file,
(c) enable the text file and optimized image file to be accessible through a network by a web browser.
